(19) United States
(12) Patent Application Publication
(10) Pub. No.: US 2015/0186793 A1
(43) Pub. Date: Jul. 2, 2015

(54) SYSTEM AND METHOD FOR DISTANCE LEARNING WITH EFFICIENT RETRIEVAL

(71) Applicant: GOOGLE INC., Mountain View, CA (US)

(72) Inventors: Sergey Ioffe, Mountain View, CA (US); Samy Bengio, Los Altos, CA (US)

(73) Assignee: GOOGLE INC., Mountain View, CA (US)

(21) Appl. No.: 14/141,803

(22) Filed: Dec. 27, 2013

(51) Int. Cl. G06N 99/00; G06F 17/30

(52) U.S. Cl. CPC G06N 99/005; G06F 17/30979

(57) ABSTRACT

A computer-implemented method can include receiving training data that includes a set of non-matching pairs and a set of matching pairs. The method can further include calculating a non-matching collision probability for each non-matching pair of the set of non-matching pairs and a matching collision probability for each matching pair of the set of matching pairs. The method can also include generating a machine learning model that includes a first threshold and a second threshold. An unknown item and a particular known item are classified as not matching when their collision probability is less than the first threshold, and as matching when their collision probability is greater than the second threshold. The first threshold and the second threshold can be selected based on a minimization of errors in classification of matching and non-matching pairs in the training data, and a maximization of a retrieval efficiency metric.

### FIELD

The present disclosure relates to machine learning and, more particularly, to a system and method for distance metric learning with improved retrieval efficiency.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Distance metric learning generally attempts to define a distance between elements in a metric space. A distance function can be utilized to determine the distance between any two data points in the metric space. A distance function can also be used, for example, in a nearest neighbor (or approximate nearest neighbor) search to find a data point in the metric space closest to a specific input (sometimes referred to as a query). Although there are many ways of defining a distance function, such distance functions may result in unacceptably long retrieval times for high-dimensional metric spaces.

### SUMMARY

According to some embodiments of the present disclosure, a computer-implemented method is described. The method can include receiving, at a computing device having one or more processors, training data that includes a set of non-matching pairs (x₁, y₁) and a set of matching pairs (x₂, y₂). The method can further include calculating, at the computing device, a non-matching collision probability p₁(x₁, y₁) for each non-matching pair of the set of non-matching pairs, and calculating, at the computing device, a matching collision probability p₂(x₂, y₂) for each matching pair of the set of matching pairs. The method can also include generating, at the computing device, a machine learning model that includes a first threshold (T₁) and a second threshold (T₂). The machine learning model can be configured to classify an unknown item as not matching a particular known item when a collision probability between the unknown item and the particular known item is less than the first threshold (T₁), and to classify the unknown item as matching the particular known item when the collision probability between the unknown item and the particular known item is greater than the second threshold (T₂). The first threshold (T₁) and the second threshold (T₂) can be selected based on: (i) a minimization of a sum of max(0, p₁(x₁, y₁)−T₁) over the set of non-matching pairs, (ii) a minimization of a sum of max(0, T₂−p₂(x₂, y₂)) over the set of matching pairs, and (iii) a maximization of In(1/T₁)/In(1/T₂).

In further embodiments, the collision probability can be based on a plurality of hash functions. Further, the collision probability can be based on an embedding function of the machine learning model, where the embedding function maps an input in a first metric space to an output in a second metric space. The embedding function can be selected based on: (i) a minimization of the sum of max(0, p₁(x₁, y₁)−T₁) over the set of non-matching pairs, (ii) a minimization of the sum of max(0, T₂−p₂(x₂, y₂)) over the set of matching pairs, and (iii) a maximization of In(1/T₁)/In(1/T₂).

In additional embodiments, the first threshold (T₁) and the second threshold (T₂) can be selected by: determining potential values for the first threshold (T₁) based on the minimization of the sum of max(0, p₁(x₁, y₁)−T₁) over the set of non-matching pairs; determining potential values for the second threshold (T₂) based on the minimization of the sum of max(0, T₂−p₂(x₂, y₂)) over the set of matching pairs; calculating In(1/T₁)/In(1/T₂) for each of the potential values for the first threshold (T₁) and the second threshold (T₂); and selecting the first threshold (T₁) and the second threshold (T₂) based on a balancing of objectives of: (i) minimizing the sum of max(0, p₁(x₁, y₁)−T₁) over the set of non-matching pairs, (ii) minimizing the sum of max(0, T₂−p₂(x₂, y₂)) over the set of matching pairs, and (iii) maximizing In(1/T₁)/In(1/T₂).

The method can further include receiving, at the computing device, a query; determining, at the computing device, an approximate nearest neighbor to the query based on the machine learning model; and outputting, from the computing device, the approximate nearest neighbor.

According to further embodiments of the present disclosure, a computer-implemented method is described. The method can include receiving, at a computing device having one or more processors, training data that includes a set of non-matching pairs (x₁, y₁) and a set of matching pairs (x₂, y₂). The method can further include calculating, at the computing device, a non-matching collision probability p₁(x₁, y₁) for each non-matching pair of the set of non-matching pairs, and calculating, at the computing device, a matching collision probability p₂(x₂, y₂) for each matching pair of the set of matching pairs. The method can also include generating, at the computing device, a machine learning model that includes a first threshold (T₁) and a second threshold (T₂). The machine learning model can be configured to classify an unknown item as not matching a particular known item when a collision probability between the unknown item and the particular known item is less than the first threshold (T₁), and to classify the unknown item as matching the particular known item when the collision probability between the unknown item and the particular known item is greater than the second threshold (T₂). The first threshold (T₁) and the second threshold (T₂) can be selected based on: (i) a minimization of errors in classification of non-matching pairs in the training data, (ii) a minimization of errors in classification of matching pairs in the training data, and (iii) a maximization of a retrieval efficiency metric related to an expected time for retrieving an approximate nearest neighbor to a query based on the machine learning model.

According to some additional embodiments of the present disclosure, a computer system is disclosed. The computer system can include one or more processors and a non-transitory, computer readable medium. The non-transitory, computer readable medium can store instructions that, when executed by the one or more processors, cause the computer system to perform certain operations.

The operations can include receiving training data that includes a set of non-matching pairs (x₁, y₁) and a set of matching pairs (x₂, y₂). The operations can further include calculating a non-matching collision probability p₁(x₁, y₁) for each non-matching pair of the set of non-matching pairs, and calculating a matching collision probability p₂(x₂, y₂) for each matching pair of the set of matching pairs. The operations can also include generating a machine learning model that includes a first threshold (T₁) and a second threshold (T₂).

The machine learning model can be configured to classify an unknown item as not matching a particular known item when a collision probability between the unknown item and the particular known item is less than the first threshold (T₁), and to classify the unknown item as matching the particular known item when the collision probability between the unknown item and the particular known item is greater than the second threshold (T₂). The first threshold (T₁) and the second threshold (T₂) can be selected based on: (i) a minimization of a sum of max(0, p₁(x₁, y₁)−T₁) over the set of non-matching pairs, (ii) a minimization of a sum of max(0, T₂−p₂(x₂, y₂)) over the set of matching pairs, and (iii) a maximization of In(1/T₁)/In(1/T₂).

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a computer system including first and second example computing devices according to some implementations of the present disclosure;

FIG. 2 is a functional block diagram of the example second computing device of FIG. 1 according to some implementations of the present disclosure;

FIG. 3 is a flow diagram of an example technique for generating a machine learning model for performing a distance calculation and/or nearest neighbor search according to some implementations of the present disclosure; and

FIG. 4 is a flow diagram of an example technique for utilizing a machine learning model for performing a nearest neighbor search according to some implementations of the present disclosure.

### DETAILED DESCRIPTION

As mentioned above, there are many ways of determining a distance between two data points in a metric space. A distance function may be defined to provide a distance between an unknown item and all items (data points) in the metric space. Such distance functions can be utilized, e.g., to conduct nearest neighbor or approximate nearest neighbor searches (collectively, “nearest neighbor searches”). These nearest neighbor searches are useful for many machine learning functions, such as pattern recognition and/or identifying duplicate (or near duplicate) data points (web pages, images, etc.).

For relatively low-dimensional metric spaces, the use of a brute-force search method (e.g., scanning the full contents of a database) may not be time-prohibitive and, therefore, almost any distance function can be utilized for a relatively efficient retrieval. For relatively high-dimensional metric spaces, however, a brute-force method of search may result in unacceptably long retrieval times. Accordingly, it would be desirable to define a distance function that is designed for use with high-dimensional metric spaces and that provides for a relatively efficient method of retrieval such that performing nearest neighbor searches can be accomplished in a time that is sub-linear in the size of the metric space.

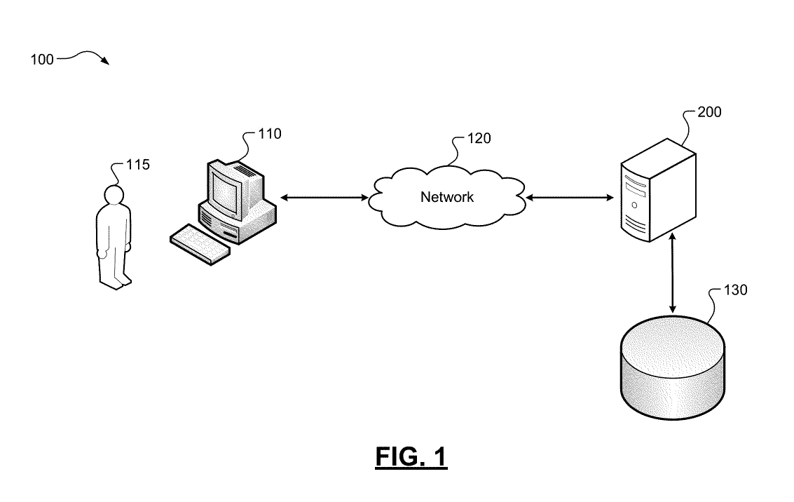

Referring now to FIG. 1, a computer system 100 for generating and utilizing a machine learning model according to some embodiments of the present disclosure is illustrated. The computer system 100 can include a first computing device 110 that is associated with a user 115. The first computing device 110 can be any type of computing device (or computing devices) such as a desktop computer, a mobile computing device (a laptop computer, a mobile phone, a tablet computer, etc.) or a server computer. The user 115 can provide input to and receive output from the first computing device 110.

The computer system 100 can further include a second computing device 200. The second computing device 200 can also be any type of computing device (or devices). The second computing device 200 communicates with the first computing device 110 through a network 120, for example, the Internet. It should be appreciated that the network 120 can describe any type of communication connection between the first computing device 110 and the second computing device 200, including but not limited to a direct connection between the first and second computing devices 110, 200. As described more fully below, the second computing device 200 can receive training data from a training data storage device 130 (such as a database or similar structure), which it can use to generate a machine learning model for performing a distance calculation/nearest neighbor search.

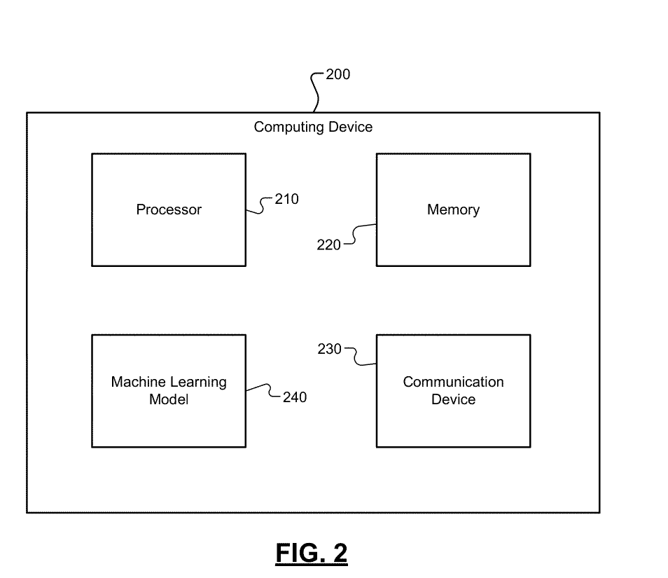

A functional block diagram of the example second computing device 200 is shown in FIG. 2. The example first computing device 100 can be the same as or similar to, and can include the same or similar components as, the second computing device 200 illustrated in FIG. 2. The second computing device 200 can include a processor 210, a memory 220 and a communication device 230. The term “processor” as used herein refers to both a single processor, as well as two or more processors operating together, e.g., in a parallel or distributed architecture, to perform operations of the second computing device 200. The second computing device 200 can further include a machine learning model 240. While shown and described herein as a separate component of the second computing device 200, the machine learning model 240 can be implemented by the processor 210. It should be appreciated that the second computing device 200 can include additional computing components that are not illustrated in FIG. 2, such as one or more input devices (a keyboard, etc.) or other peripheral components.

The memory 220 can be any suitable storage medium (Random Access Memory, flash, hard disk, etc.) configured to store information at the second computing device 200. The communication device 230 controls communication (e.g., in conjunction with the processor 210) between the second computing device 200 and other devices/networks. For example only, the communication device 230 may provide for communication between the second computing device 200 and the first computing device 100, e.g., via the network 120.

The processor 210 controls most operations of the second computing device 200. For example, the processor 210 may perform tasks such as, but not limited to, loading/controlling the operating system of the second computing device 200, loading/configuring communication parameters for the communication device 230, controlling memory 220 storage/retrieval operations, and controlling communication with the first computing device 100 via the communication device 230. Further, the processor 210 can perform the operations associated with generating, updating and utilizing the machine learning model 240 to perform a distance calculation/nearest neighbor search, as further described below.

The second computing device 200 can generate, update and utilize the machine learning model 240. The machine learning model 240 is trained to identify “matches” and “non-matches” between items (such as data points in a metric space), e.g., by utilizing a distance function. The term “matches” is not meant in a strict sense of items being exact replicas of each other. Instead, the terms “matches” and “non-matches” are meant to provide an indication of a degree of similarity between items. Accordingly, items can be classified as “matches” when the items share a measurement of similarity above a similarity threshold. Similarly, items can be classified as “non-matches” when the items share a measurement of similarity below a dissimilarity threshold.

There are various ways of estimating the measurement of similarity between items. For example only, the distance between two items in a metric space can be indicative of the similarity between the two items, with items that are a relatively shorter distance from one another being more similar to each other than items that are a relatively longer distance from one another. In some embodiments of the present disclosure, a plurality of hash functions can be utilized to determine a collision probability between items. Items for which the hash functions determine a collision probability that is below a first threshold can be classified as non-matching, while items for which the hash functions determine a collision probability that is above a second threshold can be classified as matching.

Each hash function can be utilized to generate a hash table that contains hash values for each and every known item. These hash tables can be utilized to quickly identify known items that “match” an unknown item or query. By providing the query as an input to the hash functions, hash values for the query can be determined. These hash values for the query can then be compared to the hash tables to determine the collision probability with the known items.

In order to reduce the complexity of the analysis and provide other benefits, an embedding function can be utilized with the hash functions. An embedding function can map items defined in a first metric space to a second metric space that is less complex (e.g., is of a lower dimension) than the first metric space. In this manner, items of high-dimensionality can be mapped to a lower dimensionality, which reduces the time to perform the hash functions while maintaining the distance relationship between items (although perhaps with some degree of distortion). There may be many different embedding functions available. Thus, it may be advantageous to select an embedding function that provides certain desired benefits for the distance calculation/nearest neighbor search.

In order to generate the machine learning model 240, the second computing device 200 can access the training data storage device 130 to receive training data. The training data can include a set of matching pairs (x₁, y₁) and a set of non-matching pairs (x₂, y₂). The training data is known data in that each non-matching pair (x₁, y₁) is given and labeled as a non-matching pair and each matching pair (x₂, y₂) is given and labeled as a matching pair, e.g., by a human or other expert. Based on this training data, a supervised learning algorithm can be utilized to determine a first threshold useful for identifying non-matching pairs and/or a second threshold useful for identifying matching pairs, as further described below.

The second computing device 200 can determine a non-matching collision probability p₁(x₁, y₁) for each non-matching pair (x₁, y₁) of the set of non-matching pairs. Based on the non-matching collision probabilities p₁(x₁, y₁), the machine learning model 240 can be trained to determine a first threshold (T₁) such that the machine learning model 240 is configured to classify an unknown item as not matching a particular known item when a collision probability between the unknown item and the particular known item is less than the first threshold (T₁).

Similarly, the second computing device 200 can determine a matching collision probability p₂(x₂, y₂) for each matching pair (x₂, y₂) of the set of matching pairs. Based on the matching collision probabilities P₂ (x₂, y₂), the machine learning model 240 can be trained to determine a second threshold (T₂) such that the machine learning model 240 is configured to classify an unknown item as matching a particular known item when a collision probability between the unknown item and the particular known item is greater than the second threshold (T₂). In some embodiments, the first threshold (T₁) and the second threshold (T₂) are between 0 and 1 and have the relationship that 0<(T)<(T₂)<1.

The first threshold (T₁) and the second threshold (T₂) can be selected to provide an optimization of two objectives: (1) an effective classification of an unknown item, and (2) an efficient retrieval mechanism. With respect to the first objective, it is desirable to select the first threshold (T₁) and the second threshold (T₂) such that errors in misclassification are “minimized” as a machine learning model 240 that relatively frequently misclassifies unknown items may be of limited utility. Further, with respect to the second objective, it is desirable to select the first threshold (T₁) and the second threshold (T₂) such that a retrieval time for classifying an unknown item is also “minimized” as a machine learning model 240 that has a long retrieval time may also be of limited utility.

Accordingly, the first threshold (T₁) and the second threshold (T₂) can be selected to balance these objectives, as the “minimization” of one of these objectives may not result in the “minimization” or “optimization” of the other one of these objectives. Further, it should be appreciated that the terms “minimization,” “maximization” and “optimization” as used herein are not being used in the strict sense of providing the one, absolute minimization/maximization/optimization of a quantity or system. Instead, these terms are being used in the sense of providing an acceptable level of performance of the system, based on a set of possibly countervailing objectives.

The second computing device 200 can select the first threshold (T₁) and the second threshold (T₂) based on: (i) a minimization of errors in classification of non-matching pairs in the training data, (ii) a minimization of errors in classification of matching pairs in the training data, and (iii) a maximization of a retrieval efficiency metric related to an expected time for retrieving an approximate nearest neighbor to a query based on the machine learning model 240.

The first threshold (T₁) and the second threshold (T₂) can be selected by: (i) determining potential values for the first threshold (T₁) based on the minimization of errors in classification of non-matching pairs in the training data, and (ii) determining potential values for the second threshold (T₂) based on the minimization of errors in classification of matching pairs in the training data. For each of the potential values for the first threshold (T₁) and the second threshold (T₂), a potential retrieval efficiency metric can be calculated. From the potential values, the first threshold (T₁) and the second threshold (T₂) can be selected based on a balancing of objectives of: (i) the minimization of errors in classification of non-matching pairs in the training data, (ii) the minimization of errors in classification of matching pairs in the training data, and (iii) the maximization of a retrieval efficiency metric.

In some embodiments, the minimization of errors in classification of non-matching pairs in the training data can be based on a minimization of a sum of max(0, p₁(x₁, y₁)−T₁) over the set of non-matching pairs. Further, the minimization of errors in classification of matching pairs in the training data can be based on a minimization of a sum of max(0, T₂−p₂(x₂, y₂)) over the set of matching pairs. Additionally, the maximization of the retrieval efficiency metric related to an expected time for retrieving an approximate nearest neighbor to a query based on the machine learning model 240 can be based on a maximization of In(1/T₁)/In(1/T₂). In this manner, the objectives of: (1) an effective classification of an unknown item (represented as minimizing the errors in classification of matching and non-matching pairs), and (2) an efficient retrieval mechanism (represented as maximizing a retrieval efficiency metric) can be realized.

As mentioned above, an embedding function can be utilized with one or more hash functions to determine a collision probability between two items, and the selection of an appropriate embedding function can provide certain desired benefits for the distance calculation/nearest neighbor search. In some embodiments of the present disclosure, the embedding function can be selected based on objectives similar to those discussed above. That is, the embedding function can be selected based on: (i) a minimization of errors in classification of non-matching pairs in the training data, (ii) a minimization of errors in classification of matching pairs in the training data, and (iii) a maximization of a retrieval efficiency metric related to an expected time for retrieving an approximate nearest neighbor to a query based on the machine learning model 240.

For example only, multiple machine learning models 240 can be generated, each of which corresponding to one of a plurality of potential embedding functions. The performance of each of these machine learning models 240 can be analyzed to ascertain the most desirable (or optimized) performance with respect to the objectives described above. From this analysis, a particular embedding function can be selected and utilized with the machine learning model 240.

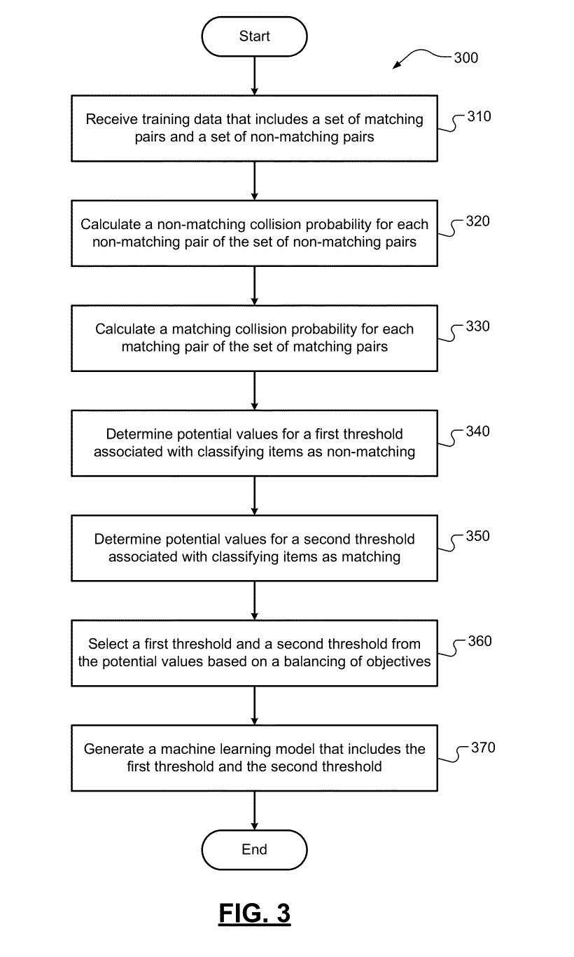

Referring now to FIG. 3, an example method 300 for generating a machine learning model (such as machine learning model 240) is illustrated. The method 300 will be described as being performed by the second computing device 200, but it should be appreciated that the method 300 can be performed by any computing device or plurality of computing devices, e.g., working in a parallel or distributed architecture. Accordingly, the term “computing device” as used herein refers to both a single computing device as well as two or more computing devices.

At 310, the second computing device 200 can receive training data that includes a set of non-matching pairs and a set of matching pairs. The second computing device 200 can calculate a non-matching collision probability for each non-matching pair of the set of non-matching pairs at 320. Similarly, at 330 the second computing device 200 can calculate a matching collision probability for each matching pair of the set of matching pairs. The second computing device 200 can determine potential values for a first threshold associated with classifying items as non-matching (340) and potential values for a second threshold associated with classifying items as matching (350).

At 360, the second computing device 200 can select a first threshold (T₁) and a second threshold (T₂) from the determined potential values. As described more fully above, the machine learning model 240 can be configured to classify an unknown item as not matching a particular known item when a collision probability between the unknown item and the particular known item is less than the first threshold (T₁). Also, the machine learning model 240 can be configured to classify an unknown item as matching a particular known item when a collision probability between the unknown item and the particular known item is greater than the second threshold (T₂). Various example methods for, and numerous example factors associated with, the selection of the first threshold (T₁) and the second threshold (T₂) are described in detail above and, thus, will not be repeated here. At 370, the second computing device 200 generates a machine learning model that includes the selected first threshold (T₁) and second threshold (T₂).

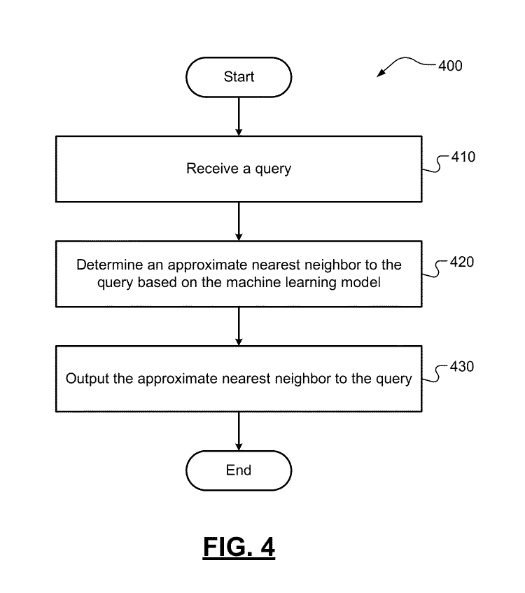

Referring now to FIG. 4, a flow diagram of an example method 400 for utilizing the machine learning model 240 for performing a nearest neighbor search according to some implementations of the present disclosure is illustrated. Similar to the method 300 above, the method 400 will be described as being performed by the second computing device 200, but it should be appreciated that the method 300 can be performed by any one or more computing devices.

At 410, the second computing device 200 receives a query. A query can be any unknown item or data point for which an approximate nearest neighbor is to be conducted. At 420, the second computing device 200 can utilize the machine learning model 240 to determine an approximate nearest neighbor to the query. For example only, the machine learning model 240 can identify one or more known items that match the query. A distance calculation can be performed between the query and each of the one or more known items that are classified as matching the query to determine the approximate nearest neighbor. Alternatively, the machine learning model 240 can identify a “most similar” known item to the query based on the collision probabilities. Other methods of identifying an approximate nearest neighbor to the query from the machine learning model 240 are also contemplated. Once determined, the approximate nearest neighbor is output by the second computing device 200 at 430.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms.

These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a computing device having one or more processors, training data that includes a set of non-matching pairs (x₁, y₁) and a set of matching pairs (x₂, y₂);
calculating, at the computing device, a non-matching collision probability p₁(x₁, y₁) for each non-matching pair of the set of non-matching pairs;
calculating, at the computing device, a matching collision probability p₂(x₂, y₂) for each matching pair of the set of matching pairs; and
generating, at the computing device, a machine learning model that includes a first threshold (T₁) and a second threshold (T₂), the machine learning model being configured to classify an unknown item as not matching a particular known item when a collision probability between the unknown item and the particular known item is less than the first threshold (T₁), and to classify the unknown item as matching the particular known item when the collision probability between the unknown item and the particular known item is greater than the second threshold (T₂),
wherein the first threshold (T₁) and the second threshold (T₂) are selected based on: (i) a minimization of a sum of max(0, p₁(x₁, y₁)−T₁) over the set of non-matching pairs, (ii) a minimization of a sum of max(0, T₂−p₂(x₂, y₂)) over the set of matching pairs, and (iii) a maximization of In(1/T₁)/In(1/T₂).

2. The computer-implemented method of claim 1, wherein calculating the collision probability is based on a plurality of hash functions.

3. The computer-implemented method of claim 2, wherein calculating the collision probability is further based on an embedding function of the machine learning model, the embedding function mapping an input in a first metric space to an output in a second metric space.

4. The computer-implemented method of claim 3, wherein the embedding function is selected based on: (i) a minimization of the sum of max(0, p₁(x₁, y₁)−T₁) over the set of non-matching pairs, (ii) a minimization of the sum of max(0, T₂−p₂(x₂, y₂)) over the set of matching pairs, and (iii) a maximization of In(1/T₁)/In(1/T₂).

5. The computer-implemented method of claim 1, wherein the first threshold (T₁) and the second threshold (T₂) are selected by:
determining potential values for the first threshold (T₁) based on the minimization of the sum of max(0, p₁(x₁, y₁)−T₁) over the set of non-matching pairs;
determining potential values for the second threshold (T₂) based on the minimization of the sum of max(0, T₂−p₂(x₂, y₂)) over the set of matching pairs;
calculating In(1/T₁)/In(1/T₂) for each of the potential values for the first threshold (T₁) and the second threshold (T₂); and
selecting the first threshold (T₁) and the second threshold (T₂) based on a balancing of objectives of: (i) minimizing the sum of max(0, p₁(x₁, y₁)−T₁) over the set of non-matching pairs, (ii) minimizing the sum of max(0, T₂−p₂(x₂, y₂)) over the set of matching pairs, and (iii) maximizing In(1/T₁)/In(1/T₂).

6. The computer-implemented method of claim 1, further comprising:
receiving, at the computing device, a query;
determining, at the computing device, an approximate nearest neighbor to the query based on the machine learning model; and
outputting, from the computing device, the approximate nearest neighbor.

7. A computer-implemented method, comprising:
receiving, at a computing device having one or more processors, training data that includes a set of non-matching pairs (x₁, y₁) and a set of matching pairs (x₂, y₂);
calculating, at the computing device, a non-matching collision probability p₁(x₁, y₁) for each non-matching pair of the set of non-matching pairs;
calculating, at the computing device, a matching collision probability p₂(x₂, y₂) for each matching pair of the set of matching pairs; and
generating, at the computing device, a machine learning model that includes a first threshold (T₁) and a second threshold (T₂), the machine learning model being configured to classify an unknown item as not matching a particular known item when a collision probability between the unknown item and the particular known item is less than the first threshold (T₁), and to classify the unknown item as matching the particular known item when the collision probability between the unknown item and the particular known item is greater than the second threshold (T₂),
wherein the first threshold (T₁) and the second threshold (T₂) are selected based on: (i) a minimization of errors in classification of non-matching pairs in the training data, (ii) a minimization of errors in classification of matching pairs in the training data, and (iii) a maximization of a retrieval efficiency metric related to an expected time for retrieving an approximate nearest neighbor to a query based on the machine learning model.

8. The computer-implemented method of claim 7, wherein calculating the collision probability is based on a plurality of hash functions.

9. The computer-implemented method of claim 8, wherein calculating the collision probability is further based on an embedding function of the machine learning model, the embedding function mapping an input in a first metric space to an output in a second metric space.

10. The computer-implemented method of claim 9, further comprising:
selecting, at the computing device, the embedding function from a plurality of potential embedding functions based on: (i) a minimization of errors in classification of non-matching pairs in the training data, (ii) a minimization of errors in classification of matching pairs in the training data, and (iii) a maximization of the retrieval efficiency metric.

11. The computer-implemented method of claim 7, wherein the retrieval efficiency metric comprises In(1/T₁)/In(1/T₂).

12. The computer-implemented method of claim 7, wherein the minimization of errors in classification of non-matching pairs in the training data comprises minimizing a sum of max(0, p₁(x₁, y₁)−T₁) over the set of non-matching pairs.

13. The computer-implemented method of claim 7, wherein the minimization of errors in classification of matching pairs in the training data comprises minimizing a sum of max(0, T₂−p₂(x₂, y₂)) over the set of matching pairs.

14. The computer-implemented method of claim 7, wherein the first threshold (T₁) and the second threshold (T₂) are selected by:
determining potential values for the first threshold (T₁) based on the minimization of errors in classification of non-matching pairs in the training data;
determining potential values for the second threshold (T₂) based on the minimization of errors in classification of matching pairs in the training data;
calculating a potential retrieval efficiency metric for each of the potential values for the first threshold (T₁) and the second threshold (T₂); and
selecting the first threshold (T₁) and the second threshold (T₂) based on a balancing of objectives of: (i) the minimization of errors in classification of non-matching pairs in the training data, (ii) minimization of errors in classification of matching pairs in the training data, and (iii) maximizing the retrieval efficiency metric.

15. A computer system, comprising:
one or more processors; and
a non-transitory, computer readable medium storing instructions that, when executed by the one or more processors, cause the computer system to perform operations comprising:
receiving training data that includes a set of non-matching pairs (x₁, y₁) and a set of matching pairs (x₂, y₂),
calculating a non-matching collision probability p₁(x₁, y₁) for each non-matching pair of the set of non-matching pairs,
calculating a matching collision probability p₂(x₂, y₂) for each matching pair of the set of matching pairs, and
generating a machine learning model that includes a first threshold (T₁) and a second threshold (T₂), the machine learning model being configured to classify an unknown item as not matching a particular known item when a collision probability between the unknown item and the particular known item is less than the first threshold (T₁), and to classify the unknown item as matching the particular known item when the collision probability between the unknown item and the particular known item is greater than the second threshold (T₂),
wherein the first threshold (T₁) and the second threshold (T₂) are selected based on: (i) a minimization of a sum of max(0, p₁(x₁, y₁)−T₁) over the set of non-matching pairs, (ii) a minimization of a sum of max(0, T₂−p₂(x₂, y₂)) over the set of matching pairs, and (iii) a maximization of In(1/T₁)/In(1/T₂).

16. The computer system of claim 15, wherein calculating the collision probability is based on a plurality of hash functions.

17. The computer system of claim 16, wherein calculating the collision probability is further based on an embedding function of the machine learning model, the embedding function mapping an input in a first metric space to an output in a second metric space.

18. The computer system of claim 17, wherein the embedding function is selected based on: (i) a minimization of the sum of max(0, p₁(x₁, y₁)−T₁) over the set of non-matching pairs, (ii) a minimization of the sum of max(0, T₂−p₂(x₂, y₂)) over the set of matching pairs, and (iii) a maximization of In(1/T₁)/In(1/T₂).

19. The computer system of claim 15, wherein the first threshold (T₁) and the second threshold (T₂) are selected by:
determining potential values for the first threshold (T₁) based on the minimization of the sum of max(0, p₁(x₁, y₁)−T₁) over the set of non-matching pairs;
determining potential values for the second threshold (T₂) based on the minimization of the sum of max(0, T₂−p₂(x₂, y₂)) over the set of matching pairs;
calculating In(1/T₁)/In(1/T₂) for each of the potential values for the first threshold (T₁) and the second threshold (T₂); and
selecting the first threshold (T₁) and the second threshold (T₂) based on a balancing of objectives of: (i) minimizing the sum of max(0, p₁(x₁, y₁)−T₁) over the set of non-matching pairs, (ii) minimizing the sum of max(0, T₂−p₂(x₂, y₂)) over the set of matching pairs, and (iii) maximizing In(1/T)/In(1/T₂).

20. The computer system of claim 15, wherein the operations further comprise:
receiving a query; and
determining an approximate nearest neighbor to the query based on the machine learning model; and
outputting, from the computing device, the approximate nearest neighbor.
